(19) United States
(12) Patent Application Publication
(10) Pub. No.: US 2025/0020158 A1
(43) Pub. Date: Jan. 16, 2025

(54) QUICK-UNLOCKING ROBUST LOCKING WASHER AND FASTENING SYSTEM PROVIDED WITH SUCH A LOCKING WASHER

(71) Applicant: Airbus Operations (S.A.S.), Toulouse (FR)

(72) Inventors: Gérard MILLET, Toulouse (FR); Simon FOUCART-GAUDY, Toulouse (FR); Thierry LOPEZ, Toulouse (FR)

(21) Appl. No.: 18/768,692

(22) Filed: Jul. 10, 2024

(30) Foreign Application Priority Data
Jul. 11, 2023 (FR) 2307401

(51) Int. Cl. F16B 39/24

(52) U.S. Cl. CPC F16B 39/24

(57) ABSTRACT

A locking washer includes an annular main component with a ring equipped, on its inner periphery, with flexible tabs which are curved such that their free ends deviate, on the same side, from a plane formed by the ring and substantially define arcs of the same circle, which is referred to as the locking circle, to produce efficient locking and to obtain a robust locking washer, the locking washer also including an annular auxiliary component to interact with the main component to quickly unlock the locking washer.

### TECHNICAL FIELD

The disclosure herein relates to a quick-unlocking robust locking washer and to a fastening system provided with such a locking washer.

The disclosure herein more particularly relates to a locking washer (or lock washer) for a screw-fastening system intended to fasten at least two components together. Such a screw-fastening system may be used in a large number of fields and in particular in the aeronautical field.

### BACKGROUND

In the aeronautical field, although not exclusively, such screw-fastening systems are, in particular, used to fasten covering panels to support structures of an aircraft, for example of a transport plane.

In such an application, each panel is fastened using a plurality of screw-fastening systems to the support structure of the aircraft, while simultaneously meeting alignment tolerances and achieving flexibility in terms of installation.

Conventionally, such a fastening system has a screw, the shank of which passes through openings in the panel and the structure that are to be fastened together. This shank is generally provided, on the panel side, with a head with which a washer is generally associated and, on the structure side, with a nut, for example a self-locking nut. A locking washer (or lock washer) that is intended to prevent the screw from turning under the effect of vibrations, in particular, may be mounted longitudinally on the shank at the region of contact between the two components. Generally, such a locking washer comprises a planar annular component provided, on its inner periphery, with tabs (or teeth) that are intended to engage in the thread of the screw in the event of vibrations, for example.

When it is desired to separate a panel fastened in this manner from the support structure, the nuts are removed from the fastening system and the panel is removed. The screws thus continue to be held on the panel by virtue of the locking washers. However, locking washers frequently become detached from their screw in such a configuration, on account of their low mechanical inertia, and fall into the aircraft, as do the screws sometimes.

There is therefore a need to find a solution that makes it possible to avoid such an undesired detachment.

### SUMMARY

The disclosure herein relates to a locking washer that makes it possible to provide a solution to meet the abovementioned need, the locking washer comprising an annular main component provided with a ring equipped, on its inner periphery, with at least two tabs arranged radially toward the inside, each of the tabs being connected, by a first end, to the ring and comprising an opposite second end, which is referred to as the free end.

According to the disclosure herein, the tabs of the annular main component are flexible and are curved such that their free ends deviate, on the same side, from a plane formed by the ring and substantially define arcs of the same circle, which is referred to as the locking circle.

Thus, by virtue of the disclosure herein, due to this curved shape of the tabs, which therefore have a non-right angle with respect to the axis of revolution of the ring of the main component (corresponding to the axis of a screw shank on which the locking washer is intended to be mounted), the holding (or locking) is more effective and the separation is more difficult, which makes it possible to make the locking washer more robust and to prevent it (when it is in a locking position on a screw) from inadvertently becoming detached from the screw and thus to meet the abovementioned need.

Advantageously, the locking circle of the locking washer has a diameter between two predetermined values, which are specified below.

The peripheral edges of the free ends of the tabs may have various shapes, in particular planar shapes. However, preferably, the peripheral edges of the free ends of the tabs are rounded so as to each closely follow an arc of the locking circle.

Furthermore, advantageously, the tabs are bent (that is to say curved, taking the shape of a bend).
a. In one preferred embodiment, the locking washer also comprises an annular auxiliary component that interacts with the main component and is arranged coaxially with the main component on the side opposite the side toward which the free ends of the tabs deviate, and the auxiliary component is provided with a ring equipped with an inner rim, which projects toward the main component.
b. This auxiliary component interacts with the main component in such a manner as to make it possible to easily and quickly unlock the locking washer in order to detach it from a screw on which it is mounted, as specified below.
c. In one particular embodiment, the rim of the auxiliary component has a conical shape.

Furthermore, advantageously, in a position referred to as the unlocking position, the main component is pressed against the auxiliary component in such a manner that the peripheral edges of the free ends of the flexible tabs of the main component form a circle, which is referred to as the unlocking circle and has a diameter that is greater than the diameter of the locking circle and larger than a predetermined value, as specified below.

The disclosure herein also relates to a fastening system having at least one screw comprising a shank provided, at one longitudinal end, with a head and, at the other longitudinal end, with a projecting annular edge as well as a locking washer mounted on the shank of the screw.

According to the disclosure herein, the locking washer corresponds to a locking washer such as the one described above, and the diameter of the locking circle formed by the tabs of the main component of the locking washer is larger than the diameter of the shank of the screw and smaller than the diameter of the annular edge of the screw.

In addition, advantageously, the diameter of the unlocking circle of the locking washer is larger than the diameter of the projecting annular edge of the screw.

### BRIEF DESCRIPTION OF THE DRAWINGS

The appended figures will make it easy to understand how the disclosure herein may be implemented. In these figures, identical reference signs denote similar elements.

FIG. 1 is a partially cross-sectional view of a screw-fastening system comprising a locking washer in accordance with one particular embodiment of the disclosure herein, the fastening system assisting in fastening a panel to a support structure.

FIG. 2 shows, in cross section, the portion of the panel in FIG. 1 that is provided with the screw of the fastening system and with the locking washer in the locking position.

FIG. 3 is a figure similar to that of FIG. 2, the washer being brought into the unlocking position and the screw being in the process of being removed from the panel.

FIG. 4 is a schematic perspective view of a screw of a fastening system on which a locking washer according to one particular embodiment is mounted in the locking position.

FIG. 5 is a figure similar to that of FIG. 4, the locking washer being in the unlocking position.

FIG. 6 is a schematic perspective view of a main component of one particular embodiment of a locking washer.

FIG. 7 is a schematic perspective view of an auxiliary component of one particular embodiment of a locking washer.

### DETAILED DESCRIPTION

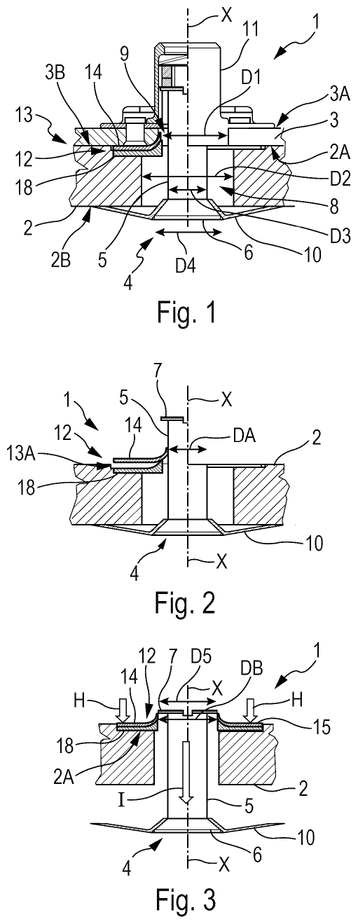

A (screw-) fastening system 1 such as the one shown in one particular embodiment in FIG. 1 is intended to fasten at least two components 2 and 3 (shown partially in this FIG. 1 in a fastening position) together.

This fastening system 1 may be used in a number of fields and in particular in the aeronautical field. In the aeronautical field, fastening systems 1 are more particularly used to fasten covering panels to support structures of an aircraft, in particular of a transport plane.

Thus, in a preferred application in the aeronautical field, the component 2 is a (wall covering) panel and the component 3 is a support structure intended to receive this panel 2. This support structure 3 may in particular be secured to an inner portion of the fuselage of the aircraft, for example in the hold of the aircraft.

The following description relates to such a preferred application. In this application, each panel 2 is fastened using a plurality of fastening systems 1 (only one of which is shown in FIG. 1, as well as in FIGS. 2 and 3) to the support structure 3.

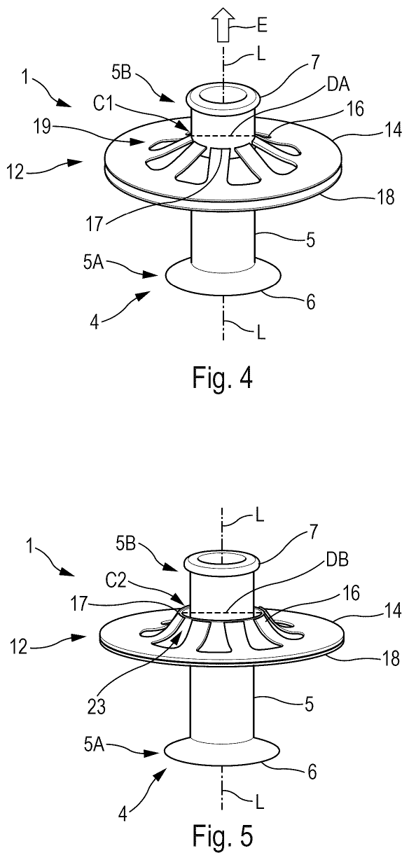

The fastening system 1 has, as shown in FIGS. 4 and 5, a screw 4 comprising a shank 5 that has a cylindrical shape and a longitudinal axis L-L. This shank 5 is at least partially threaded and is provided, at a first longitudinal end 5A, with a head 6 and, at the second longitudinal end 5B, with a radially projecting annular edge 7.

In the fastening position in FIG. 1, the shank 5 of the screw 1 passes through both an opening 8 (in the shape of a right circular cylinder) formed in the panel 2 and an opening 9 (in the shape of a right circular cylinder) formed in the support structure 3. The openings 8 and 9 are aligned and coaxial with an axis X-X.

In this fastening position, the longitudinal axis L-L of the shank 5 of the screw 4 is substantially coaxial with the axis X-X, with the possibility of clearance in order to allow freedom during mounting.

In the following description:
the terms “inner” and “outer” are defined with respect to these axes X-X and L-L, “inner” corresponding to elements that are located radially toward these axes X-X and L-L, and “outer” corresponding to elements that are located radially away from these axes X-X and L-L; and
the terms “upper” and “lower” are defined with respect to the direction of an arrow E (FIGS. 4, 6 and 7) that is substantially parallel to the axes X-X and L-L, “upper” corresponding to elements that are located in the direction of the arrow E, and “lower” corresponding to elements that are located in the opposite direction to that of the arrow E.

More particularly, the diameter D1 of the opening 9 and the diameter D2 of the opening 8 are greater than the diameter D3 of the shank 5 of the screw 4, as shown in FIG. 1, in order to ensure a clearance and thus to provide flexibility during installation.

In the example in FIG. 1, the diameter D3 of the opening 8 is even larger than the diameter D4 of the head 6 of the screw 4. In this example, the fastening system 1 thus comprises, in addition, a washer 10 that rests on a lower face 2B of the panel 2 around the opening 8 and is arranged between the panel 2 and the head 6 of the screw 4.

The fastening system 1 also has a conventional nut 11, for example a self-locking anchor nut, which rests against an upper face 3A of the support structure 3 and which is conventionally fastened to the longitudinal end 5B of the shank 5 of the screw 4.

Consequently, the panel 2 and the support structure 3 (the lower face 3B of which rests on the upper face 2A of the panel 2) are held together by the fastening system 1, via the contact between the washer 10 and the lower face 2B of the panel 2 and the contact between the nut 11 and the upper face 3A of the support structure 3, and are both connected to the screw 4.

The fastening system 1 also has a locking washer 12 (or lock washer) that is mounted on the shank 5 of the screw 4, as shown in FIGS. 1 to 5.

The locking washer 12 is intended to prevent the screw 4 from turning under the effect of vibrations, in particular. The washer is mounted on the shank 5 at a region of contact 13 (FIG. 1) between the panel 2 and the support component 3. A housing 13A (FIG. 2) formed in the panel 2 on the upper face 2A is provided, at the region of contact 13, in order to receive the locking washer 12.

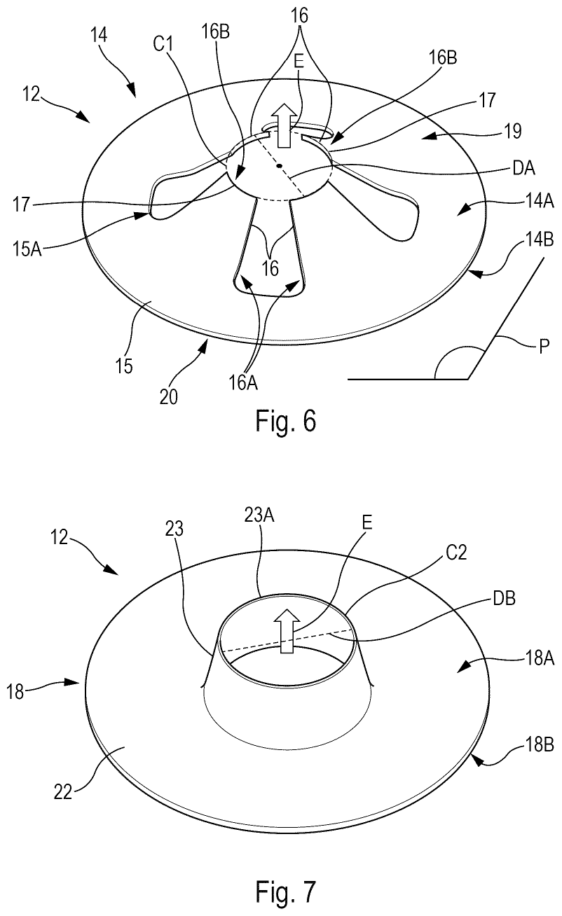

As shown in FIGS. 4 and 5 in particular, the locking washer 12 comprises an annular main component 14. This main component 14 is provided, as shown in FIG. 6, with a ring 15 that is equipped, on its radially inner periphery 15A, with a plurality of tabs 16 arranged radially toward the inside.

In the example in FIG. 6, the main component 14 comprises four tabs 16, and in the example in FIGS. 4 and 5, the main component 14 comprises around ten tabs 16.

Each of the tabs 16 of the main component 14 is connected, by a first end 16A, to the ring 15 and comprises a second end (opposite this first end 16A), which is referred to as the free end 16B.

The tabs 16 of the main component 14 are flexible. In addition, they are curved such that their free ends 16B deviate, on the same side 19, with respect to a plane P formed by the ring 15 in the direction of the arrow E (FIG. 6). The peripheral edges 17 (that is to say the inner edges) of the free ends 16B of the tabs 16 substantially define arcs of one and the same circle, which is referred to as the locking circle C1. The peripheral edges 17 are not present over the entirety of the locking circle C1, but merely form circular arcs, next to one another, along the locking circle C1.

The locking circle C1 has a diameter DA (FIGS. 4 and 6) that is slightly larger than the diameter D3 (FIG. 1) of the threaded shank 5 of the screw 4 and smaller than the diameter D5 (FIG. 3) of the annular edge 7 of the screw 4, which prevents the locking ring 12 from being freed via the annular edge 7 (which projects radially toward the outside) in the configuration in FIG. 2 specified below.

In one preferred embodiment, the tabs 16 are distributed uniformly around the periphery 15A of the ring 15. In addition, preferably, the tabs 16 of the main component 14 of the locking washer 12 are identical. It is, however, also conceivable for the tabs 16 to be able to have different widths, but with identical lengths, so that the peripheral edges 17 of the free ends 16B of these tabs 16 are all located at the locking circle C1.

In the context of the disclosure herein, the peripheral edges 17 of the free ends 16B of the tabs 16 may have various shapes, in particular planar shapes. However, preferably, the peripheral edges 17 of the free ends 16B of the tabs 16 are rounded (in a circular arc) so as to each closely follow an arc of the locking circle C1, as shown in FIG. 6.

In the context of the disclosure herein, the tabs 16 may have various curved shapes. However, in one preferred embodiment, the tabs 16 are bent, meaning that they are curved into the shape of a bend and therefore each comprise two substantially rectilinear segments, which have different directions and are connected together at the bend.

Due to this curved (in the direction of the arrow E) shape of the tabs 16, with a non-right angle with respect to the axis of revolution of the ring 15 of the main component 14 (corresponding to the longitudinal axis L-L of the shank 5 of the screw 4 on which the locking washer 12 is mounted), which enables them to grip better, the locking or holding of the locking washer 12 on the screw 4 is more effective than if the tabs (or teeth) were located in the plane of the ring and thus had a right angle with respect to the axis of revolution of the ring. This curved shape of the tabs 16 makes it possible to prevent the locking washer 12 from inadvertently becoming detached (in the configuration in FIG. 2) and thus to obtain a more robust locking washer 12.

Additionally, in order to be able to remove the locking washer 12 more easily from a screw 4 on which it is mounted, the locking washer 12 comprises, in addition to the main component 14, an annular auxiliary component 18. This auxiliary component 18 is intended to interact with the main component 14 in order to unlock the latter, so that the locking washer 12 can be removed from the screw 4.
a. The auxiliary component 18 is arranged coaxially with the main component 14 on the side 20 (FIG. 6) opposite the side 19 toward which the free ends 16B of the tabs 16 deviate.
b. The auxiliary component 18 is provided, as shown in FIG. 7, with a ring 22 equipped with an inner rim 23, which has a conical shape and projects toward the main component 14, in the direction of the arrow E.
C. This auxiliary component 18 makes it possible to easily and quickly unlock the main component 14, and therefore the locking washer 12, as specified below.
d. In one particular embodiment, the rim 23 of the auxiliary component 18 has a triangular shape in cross section.

The locking washer 12 provided with the main component 14 and with the auxiliary component 18 may in particular assume two positions, a locking position and an unlocking position, as illustrated in FIGS. 4 and 5, respectively.

In the locking position in FIG. 4, the auxiliary component 18 does not act on the main component 14, which takes the form of the example in FIG. 6 with its tabs 16 that define the locking circle C1.

The locking circle C1 has a diameter DA (FIGS. 4 and 6) that is slightly larger than the diameter D3 (FIG. 1) of the threaded shank 5 of the screw 4 and smaller than the diameter D5 (FIG. 3) of the annular edge 7 of the screw. Thus, in this locking position, the locking washer 12 is held on the shank 5 of the screw 4, as shown in FIG. 4.

The locking washer 12 makes it possible, by virtue of the curved shapes of the tabs 16 of the main component 14, to effectively engage against the threaded shank 5 of the screw 4 in order to implement its locking washer (or lock washer) functions.

In addition, its tabs 16 make it possible to firmly hold the locking washer 12 on the shank 5 of the screw 4 in the locking position shown in FIGS. 2 and 4 and to avoid the locking washer becoming detached therefrom.

Furthermore, in the unlocking position shown in FIGS. 3 and 5, the main component 14 is pressed against the auxiliary component 18 (which bears against the upper face 2A of the panel 2 (as can be seen in FIG. 3)) in such a manner that the peripheral ends 17 of the free ends 16B of the tabs 16 of the main component 14 form a circle, which is referred to as the unlocking circle C2. The unlocking circle C2 has a diameter DB that is greater than the diameter DA of the locking circle C1. In addition, this diameter DB is also larger than the diameter D4 of the annular edge 7 of the screw 4.

It is thus possible to separate the screw 4 and the locking washer 12. In order to be able to easily remove the locking washer 12 from the shank 5 of the screw 4, the locking washer 12 is brought into the unlocking position in FIGS. 3 and 5.

The different positions and configurations of the locking washer 12 and of the fastening system 1, as respectively shown in FIGS. 1 to 3, are presented in more detail below.

In the configuration in FIG. 1, the panel 2 is fastened using a plurality of fastening systems 1 (only one of which is shown in this FIG. 1) to the support structure 3. To this end, the washer 10 associated with the head 6 of the screw 4 is in contact with the lower face 2B of the panel 2, and the nut 11, which is in contact with the upper face 3A of the support structure 3, is secured to the shank 5 of the screw 4. In addition, the locking washer 12 is in place on the shank 5 of the screw 4 and is arranged in the housing 13A at the interface 13 between the panel 2 and the support structure 3.

In the configuration in FIG. 2, compared to the one in FIG. 1, the nut 11 has been removed and the panel 2 (with the screw 4 and the locking washer 12) has been separated from the structural element 3. The locking washer 12, which is in its locking position, remains connected to the screw 4 and the assembly thus remains secured to the panel 2.

Starting from the configuration in FIG. 2, in order to separate the locking washer 12 from the shank 5 of the screw 4, a separation process is implemented.

This separation process comprises the following operations or steps:
a first step, during which a pressure is exerted on the upper face 14A (FIG. 6) of the main component 14, preferably on the ring 15 of this main component 14, as illustrated by arrows H in FIG. 3, in such a manner that the upper face is pressed against the upper face 18A (FIG. 7) of the auxiliary component 18, the lower face 18B of the auxiliary component 18 bearing against the upper face 2A of the panel 2. Due to this pressure and on account of the flexibility of the tabs 16, the lower face 14B of the main component 14 will come into contact with the upper face 18A of the auxiliary component 18 and closely follow the shape of the face 18A. By virtue of the conical annular rim 23, the tabs 16 pressing against the face 14B will cause the peripheral edges 17 of the tabs 16 to be radially displaced toward the outside and thus increase the circle formed by the peripheral edges 17. When the main component 14 is completely pressed against the auxiliary component 18, the peripheral edges 17 define the unlocking circle C2. The diameter DB of this unlocking circle C2 is of course larger than the diameter DA of the locking circle C1, and also than the diameter D5 (FIG. 3) of the annular edge 7 of the screw 4; and
a second step, during which, while maintaining the abovementioned pressure illustrated by the arrows H so that the peripheral edges 17 of the free ends 16B of the tabs 16 form the unlocking circle C2, the screw 4 is acted upon in order to remove it from the locking washer 12, as illustrated by an arrow I (in the opposite direction to that of the arrow E), and thus to detach it from the panel 2.

In one preferred embodiment, the main component 14 and the auxiliary component 18 are formed, in particular with an appropriate size of the rim 23 and of the length of the tabs 16, in such a manner that the inner contour 23A of the rim 23 has a diameter DB (FIG. 7) that is equal to the diameter of the unlocking circle C2 in the unlocking position.

In a first mode of implementation, the abovementioned first step is implemented by an operator, by pressing or pushing with some of their fingers, at least at two different locations, on the ring 15 of the main component 14 of the locking washer 12, as illustrated by the arrows H in FIG. 3.

Furthermore, in a second mode of implementation, the abovementioned first step is implemented using a tool (not shown) that makes it possible to generate the pressure illustrated by the arrows H on the ring 15 of the main component 14.

As regards the second step, it is implemented by an operator pulling on the screw 4 in the direction illustrated by the arrow I in FIG. 3, for example directly with a hand or using a tool, in particular a gripping tool.

The locking washer 12 and also the fastening system 1 that comprises it, as described above, have several advantages. In particular, they make it possible:
to produce locking or holding of the locking washer 12 on the screw 4 that is particularly effective;
to thus obtain a locking washer 12 that is robust; and
to easily and quickly unlock the locking washer 12, and thus to be able to quickly and effectively separate the locking washer 12 from the screw 4.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A locking washer comprising an annular main component with a ring comprising, on its inner periphery, at least two tabs arranged radially toward an inside, each of the tabs being connected, by a first end, to the ring and comprising an opposite second end, that is a free end, the tabs being flexible and curved such that their free ends deviate, on a same side, from a plane formed by the ring and substantially define arcs of a same circle, that is a locking circle, the locking washer also comprising an annular auxiliary component to interact with the main component and arranged coaxially with the main component on the side opposite the side toward which the free ends of the tabs deviate, the auxiliary component comprising a ring equipped with an inner rim, which projects toward the main component.

2. The locking washer of claim 1, wherein the locking circle has a diameter between two predetermined values.

3. The locking washer of claim 2, wherein peripheral edges of the free ends of the tabs are rounded to each closely follow an arc of the locking circle.

4. The locking washer of claim 1, wherein the tabs are bent.

5. The locking washer of claim 1, wherein the rim has a conical shape.

6. The locking washer of claim 1, wherein in an unlocking position the main component is pressed against the auxiliary component such that peripheral edges of the free ends of the flexible tabs of the main component form an unlocking circle and have a diameter that is greater than a diameter of the locking circle and larger than a predetermined value.

7. A fastening system having at least one screw comprising a shank comprising, at one longitudinal end, a head, and at another longitudinal end, a projecting annular edge and a locking washer mounted on the shank of the screw, wherein the locking washer is the locking washer of claim 1, and wherein a diameter of the locking circle formed by the tabs of the main component of the locking washer is larger than a diameter of the shank of the screw and smaller than a diameter of the annular edge of the screw.

8. The fastening system of claim 7, wherein in an unlocking position the main component is pressed against the auxiliary component such that peripheral edges of the free ends of the flexible tabs of the main component form an unlocking circle and have a diameter that is greater than a diameter of the locking circle and larger than a predetermined value, and wherein the diameter of the unlocking circle is larger than the diameter of the annular edge of the screw.
